(19) United States
(12) Patent Application Publication
(10) Pub. No.: US 2009/0099917 A1
(43) Pub. Date: Apr. 16, 2009

(54) Benefit management method and system for any type of bank card

(75) Inventors: Aneace Haddad, Les Arcs (FR); Frederic Mayance, Mimet (FR)

Correspondence Address: BANNER & WITCOFF, LTD., 1100 13th STREET, N.W., SUITE 1200, WASHINGTON, DC, 20005-4051, US

(73) Assignee: WELCOME REAL TIME, S.A., Aix-en Provence (FR)

(21) Appl. No.: 11/920,135

(22) PCT Filed: May 11, 2006
(86) PCT No.: PCT/FR2006/001051

§ 371 Date: Jan. 29, 2008

(30) Foreign Application Priority Data
May 12, 2005 (FR) 0504772

(51) Int. Cl. G06Q 30/00; G06Q 20/00

(52) U.S. Cl. 705/14; 705/17

(57) ABSTRACT

The invention relates to a benefit management method for a user when he pays for a transaction carried out with at least one affiliated merchant by means of a bank chip and/or magnetic card. The users application data items are stored in a chip and/or in a remote external server and a determined promotional program is stored and/or available at the merchant. The inventive method consists in questioning the chip and/or the server on the application data assigned to said card, in using eventual already obtained benefits and/or in generating new benefits according to the application data and the determined promotional program of the merchant prior to updating said application data of the user.

The present invention relates to a method for managing rewards at the time of payment by a user by bank card, with a chip (with contact and/or without contact) and/or stripe, during a transaction at least one affiliated merchant's.

“Reward” should be understood mainly to be a paper or electronic coupon, but also points stored in a register and more generally anything that concretely provides a material or financial benefit to a user and that is manifested through a technical medium (paper, but also recording of points or any type of information or data in the memory of a PDA, a mobile telephone, computers, or more generally in the memory of an electronic device).

Although a coupon should rather be considered to be a finite reward, corresponding for example to a 10 euro reduction voucher on a given product, this in a manner already defined, the points are for their part accumulated gradually as purchases are made and have no precise meaning.

They may therefore be used differently at a merchant A and at a merchant B.

For example 100 points will correspond to a free coffee at A's and to a porcelain plate at B's.

It also relates to a reward management system for any type of bank card, management of rewards having to be understood in a general manner, that is to say particularly both as concerning the issue but also the redemption of rewards, as being for example at the origin of a coupon issued electronically and/or printed on a till slip.

It finds a particularly important although not exclusive application in the field of loyalty programs designed to encourage consumers to return to the same merchant or the same group of merchants.

Systems are already known for obtaining a reduction through a paper voucher to be placed in the till during the act of purchase. This paper coupon may if necessary comprise a bar code to make it easier to process. Paper coupons are usually cut out of newspapers or else printed at a kiosk and more recently on a personal computer.

There are also solutions with specific chip cards where the reduction coupons are stored in electronic form in the chip of the card. The card is inserted into a reader at the point of sale.

When a purchased article benefits from a voucher, the system deducts the amount of the reduction from the amount of payment to be made by the consumer while updating the card.

The existing systems have disadvantages.

Paper reduction coupons specifically require cumbersome and costly management in order to distribute the offer, use the reduction at the point of sale and finally process the information. The accumulation of paper reduction vouchers by the consumer is also a brake on their use.

Solutions using a chip card to store the reduction coupons require for their part the delivery of a chip card to the consumer and the presence of a reader to process the latter in read and/or write mode. One of the disadvantages here is the necessity to put in place an end-to-end hardware infrastructure that is dedicated to the chip card.

Such known systems also provide no difference of behavior during use in closed circuit (when the reduction coupons are generated to be used in the same store that issues them) and during use outside said circuit (that is to say outside the location where they were obtained).

It is noted that the effectiveness of promotion by coupons is clearly greater when coupons are issued in the same location as they are used. Specifically, although the proportion of coupons issued in store represents of the order of 16% of all the coupons issued, it corresponds on the other hand to the order of 45% of the coupons used by consumers. No system of the prior art has however for the time being identified and taken account of these factual elements to propose a system that is more effective and dedicated to coupons generated and used on the spot.

The present invention aims to remedy these disadvantages and to provide a method and a device providing a better answer than those known hitherto to the requirements of the practice particularly in that it allows the consumer to benefit easily, thanks to his own bank payment cards, from a system allowing the application of rewards to be used at the merchants' or in a supermarket, in a simple, low-cost and easy-to-apply manner, and it does this for rewards generated and delivered in the very store of said merchant.

In other words, the invention allows the installation of an extremely powerful method or system that will notably allow the optimized management of rewards whatever the type of bank card used at the merchant's.

Therefore, because use is made without distinction of the consumer's chip and/or stripe bank cards, in general use, the invention allows the consumers to participate in the merchant's loyalty program instantaneously.

On his side, the merchant will use the consumer's bank card either to store application data therein such as information and behavior data concerning the consumer (for example RFM data—the initials for “Recency-Frequency-Monetary value”) and/or rewards acquired during previous transactions, either to initiate the obtaining of certain application data stored elsewhere on a remote server, to condition the recording and/or the issuing of rewards, without having to create a specific storage medium such as a loyalty card.

Bank cards are specifically portable objects that are secure and widely distributed, which offer many more possibilities and much more security than a simple loyalty card.

With the invention it will also be possible to produce a micro-summary of the behavior data (for example the customer's RFM or “Recency, Frequency and Monetary value” data) according to his past behavior at the merchant's.

Therefore, when the customer's bank card is analyzed by the merchant's payment terminal, the latter determines whether the application data may be obtained directly from the card.

Otherwise, the terminal obtains these application data from a remote server by means of a request known per se.

The application data are then available in real time every time the customer uses his bank card at the merchant's, which authorizes the redemption and/or the immediate issuing of rewards at the tills.

Everything is done automatically and therefore there is no need for special intervention by the consumer and the merchant.

It will be noted therefore that, with the embodiment of the invention more particularly described here, the intelligence of the system is in the payment terminal and not in a remote server. This has advantages that were not necessarily apparent to those skilled in the art.

Specifically, it is therefore here possible to process both transactions that require obtaining application data from a server, and transactions with no connection to a server because the data are stored in the card itself, with exactly the same functionalities in both cases.

Since the server is used simply for storing application data, it is easy to maintain, supervise and operate and may handle a large number of requests because it does not need to carry out cumbersome and/or complicated computations.

Finally, because of the great simplicity that is proposed, the risks of blockage are reduced, the server furthermore being able to be restarted quickly in the event of a failure.

Similarly, with the invention, a merchant will be able to recognize the first time that a user pays with his card at this merchant's. He may then offer him an introductory gift, then monitor his customer path by adapting his offers in line with the subsequent use of his bank card to pay at this merchant's.

He may for example choose to offer preferential electronic coupons to his best customers.

On the other hand, the merchant may decide to give preferential promotions to the least assiduous customers in order to encourage them to return. For example, recognizing that the customer has not been for more than 90 days, he may encourage him through a promotional till slip to return within 30 days.

The invention is based therefore and particularly, on the one hand, on the idea of dispensing with a card that requires a specific physical system with a reader for receiving the offer and its use at the point of sale, and, on the other hand, on the very powerful and surprising synergetic efficiency of a closed circuit operation for a user on the premises of the store itself.

Another advantage of the invention is that it allows the merchant to adapt his promotional offers to those that he knows are the most effective without requiring the intervention of special technical personnel and/or devices other than those that exist.

For this purpose, the invention proposes in particular a method for managing rewards at the time of payment by a user with a bank card with a chip and/or a stripe during a transaction at least one affiliated merchant's, characterized in that, application data of the user being stored in the chip and/or on an external remote server, and a determined promotional program being stored and/or valid at the merchant's, when the user uses his bank card to pay at said merchant's, the chip and/or said server is interrogated to ascertain the application data relating to this card, then any rewards already acquired are used and/or new rewards are generated as a function of said application data and of said determined promotional program of the merchant before these application data are updated.

In advantageous embodiments there is also or equally recourse to one and/or other of the following arrangements:
if the above method is used with a chip card capable of storing the application data, the promotional program processes the transaction and the payment at said merchant's without making use of an external remote server, the data used being stored in said chip;
particularly when the above method uses either a stripe card or a chip card that is not capable of storing the application data, the bank card payment authorization communication protocol or any other communication protocol is used to interrogate and communicate with the external remote server storing the application data;
for a user using a new chip card replacing an old card (with chip or stripe), the merchant's payment terminal processes the transaction making use of a remote server in which the application data of said user are stored, then said application data are written into the chip of the new card and the subsequent transactions are or are not be carried out without connection to the server;
for a user using a new card replacing an old chip card, the application data are read from the chip of the old card, the transaction is processed making use of a remote server into which the application data of the old card of said user are transferred, then the subsequent transactions are carried out with connection to the server;
the application data are the behavior data of the cardholder, for example the RFM data at the merchant's concerned, and the rewards acquired by the user during his previous transactions;
standard bank cards available on the market are used without modification and/or specific programming, the application data being stored, if appropriate, in a register of said card;
the user application data are edited in real time when the user uses his bank card at a merchant's, the codes of the articles purchased during the transaction are analyzed and when one or more articles are identified for which one or more rewards are allocated, the rewards are allocated accordingly. This may for example give rise to an automatic deduction of an amount of reductions from the total amount of the purchases.

The invention also proposes a system for printing and/or storing electronic coupons applying the method described above.

It also proposes a reward management system during the payment by a user with a bank card with a chip and/or a stripe during a transaction at least one affiliated merchant's, the system comprising:
a register, called the application register, belonging to the card or to an external remote server capable of storing the user application data,
a point-of-sale terminal for example of the payment terminal or else electronic cash register type furnished with a determined promotional program,
a card reader device for paying,
means for interrogating the content of the application register of the chip and/or of said server in order to ascertain the application data of said user,
computing means and registering means and/or means for generating rewards according to said application data and said determined promotional program of the merchant,
and means for erasing and/or for writing in said application register new user application data according to the transaction.

The means for interrogating, computing, registering and/or for generating and the means for erasing and/or writing include, in a known manner, widely available microprocessors programmed accordingly.

Advantageously, the card being a chip card, the promotional program processes the transaction and the payment at said merchant's without making use of an external remote server.

In an advantageous embodiment, the system comprises means making it possible to use the bank card payment authorization communication protocol to interrogate and communicate with the external remote server for storing application data.

Again advantageously, the bank cards are standard cards available on the market without modification and/or specific programming, the application data being stored, as appropriate, in a register of said card.

In another advantageous embodiment, the system comprises means for real time editing at the merchant's of the user application data when the user uses his bank card at a merchant's.

Equally advantageously, the system comprises a device for reading the codes of the purchased articles and means arranged for generating rewards according to the promotional program and the identified articles.

The present invention will be better understood on reading the following description of embodiments given as nonlimiting examples.

It refers to the drawings accompanying it in which:

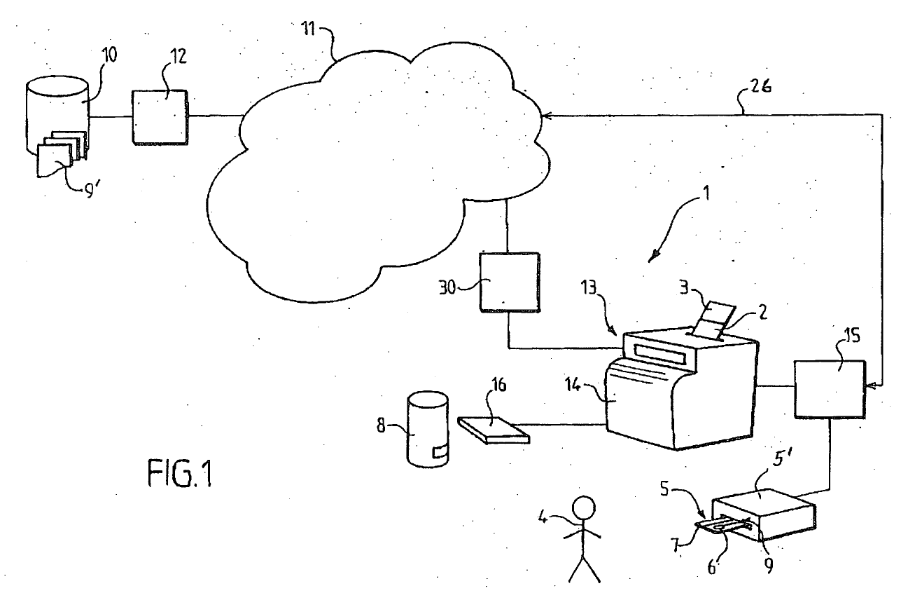

FIG. 1 is a schematic view of a system according to one embodiment of the invention.

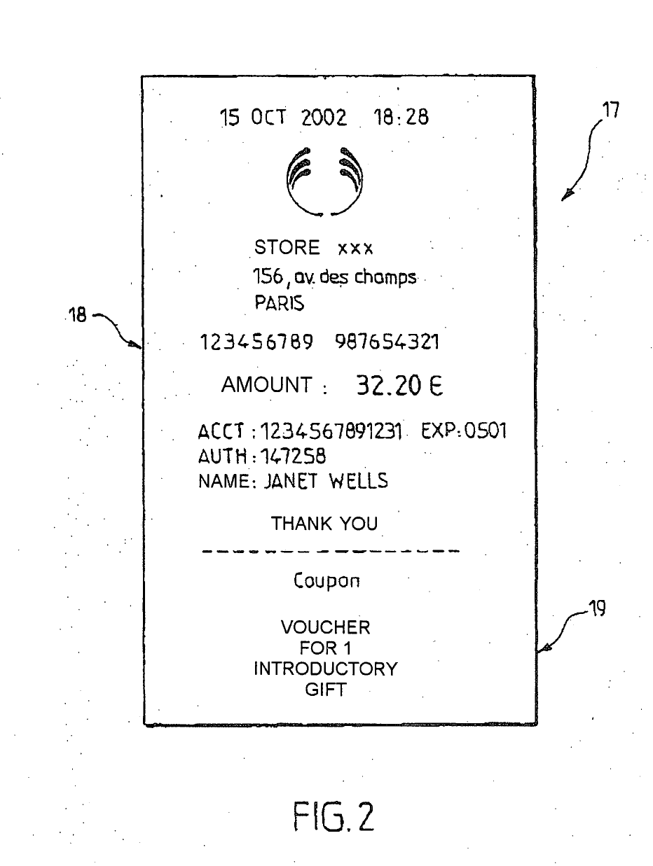

FIG. 2 gives an example of a till slip with a generated coupon, used with the method according to one embodiment of the invention.

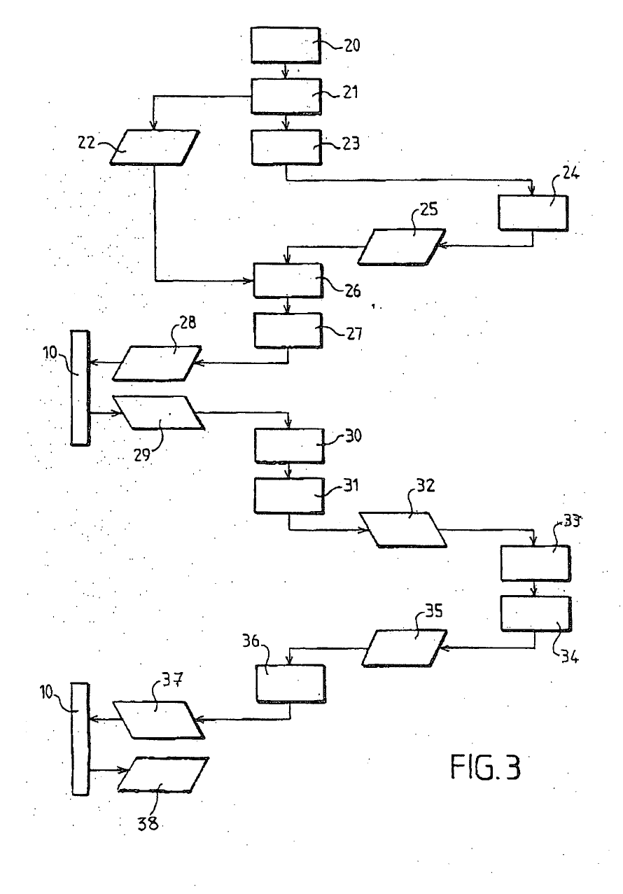

FIG. 3 is a flowchart describing schematically the steps for applying one embodiment of the method according to the invention.

FIG. 1 shows a system 1 for printing a coupon 2 on a till slip 3 during the payment by a user 4 with his bank card 5 with a chip 6 or stripe 7 inserted into a reader 5′ during the purchase of an article 8 at a merchant's.

The system comprises a register 9 belonging to the card and/or a register 9′ belonging to an external remote server 10 for example connected via the Internet network 11 to the portion of the system located at the merchant's itself via an interface 12.

The register 9 or 9′ is arranged to store the user application data, for example in the form of a file of the following type:

Field
Card number (if appropriate)

| | |
|---|---|
| 1 | Merchant Code No 1 |
| | Activity code |
| | Date of first visit |
| | Date of last visit |
| | Number of visits this month |
| | Expenditure this month |
| | Number of visits this year |
| | Expenditure this year |
| | Total number of visits |
| | Total expenditure |
| 2 | // |
| | // |
| i | Code of merchant No. i |
| | Activity code |
| | Etc. |

It will be noted here that, in this embodiment, all the fields after that of the card number, and from the Merchant Code field, are repeated for each merchant or group of merchants that the customer frequents or has frequented, and that use promotional offers.

In one embodiment of the invention, the behavior data 9′ are stored in the remote server 10 in the form of a more complete file that will in particular allow the output of the micro-summary of the record of a customer.

The file format is exactly the same as that stored in the chip and comprises several “slots”, each for example of approximately 20 bytes, to store the behavior data that indicate for example simply the amount and/or the number of visits.

The file concerning the specific merchant on whose premises the transaction takes place is then transmitted at great speed by the server.

This file has for example the following form:

| | | Value representing the | | |
|---|---|---|---|---|
| | Promotional | behavior data of the | Incremental | |
| | program | customer corresponding to | transaction | Expiry |
| Bank card identity No | reference | the bank card | counter | date |
| 1234 5678 9012 3456 | 00000012 | 010E . . . 27 | 13 | 1004 |
| 1234 5678 9012 3456 | 00000015 | 010E . . . 34 | 13 | 1004 |
| 1234 5678 9012 3456 | 00000033 | 010E . . . 55 | 10 | 0105 |
| . . . | . . . | . . . | | |

The bank card identity number is stored in a secure manner according to the required standards.

The reference numbers of the promotional programs and the value representing the behavior data are in hexadecimal format.

In the above example, the card “1234 5678 9012 3456” has activated two different proportional programs: program number 12 and program number 15. This card has also made thirteen transactions and its expiry date is October 2004.

An additional file is also advantageously provided that makes it possible to store administrative data concerning each card known on the date of creation of its image, and the date of its last update, which makes it possible in particular to purge the database of cards that are too old.

The creation of a reference to a specific card and/or its update in the file is carried out via a command called “image download request” that is received by the server 10, and that will be explained further in particular detail below.

If no reference exists, the latter is created.

Finally, at the end of a transaction, the server receives an update request, containing the representative values created, modified or erased during the transaction.

Although the file stored on the server also includes records for other merchants that the customer has already frequented, it is desirable to limit the data returned by the server to only the data relating to the merchant involved in the current transaction.

In the same manner, it is desirable to limit the data returned to the server to only the data modified during the transaction.

More precisely, the file stored on the server may be in a detailed form covering all the application data usually stored in a chip card, for example in the form of a sequence of individual objects called CARD_OBJ, ISSUER_OBJ, POOL_OBJ and COUPON_OBJ below.

### CARD OBJ:

The following table gives the list of fields commonly defined in the CARD_OBJ object:

| Name | Description |
|---|---|
| CARD_NUM | Card number, which unequivocally |
| | identifies the user for a determined |
| | card supplier |
| UTC | “Update Transaction Counter”: this field |
| | is incremented at the beginning of each |
| | transaction of a loyalty program that |
| | modifies the content of the card |
| NETWORK_ID | Identifier of an acceptance network of |
| | the “CB”, “Visa”, “Aurore”, etc. type, |
| | that uniquely identifies the network in |
| | which the card can be used. From the |
| | application point of view, this field |
| | determines whether the card is accepted |
| | by the merchant, that is to say whether |
| | it can be used by his terminal. |
| PERSO_DATE | Personalization date of the card |
| START_DATE | Date of first use of the card |
| EXP_DATE | Expiry date of the card |
| CARD_ISS_ID | Identifies unequivocally the card issuer |

### ISSUER OBJ:

A second object ISSUER_OBJ is advantageously provided.

It contains the optional data fields selected by the card issuer. The following table gives the list of fields commonly defined in the ISSUER_OBJ object:

| Name | Description |
|---|---|
| CARD_HOLDER_NAME | Name of the cardholder |
| PAN | Cardholder account number |
| BIRTH DATE | Cardholder date of birth |
| GENDER | Cardholder sex |
| MEMBERSHIP DATE | Subscription date |
| ISS_COUNTRY CODE | Country |
| ORIGIN | Nationality |
| FINANCIAL_INST | Bank |
| CLASS LEVEL | Card type |
| ACQUISITION CODE | Acquisition code |
| STAFF_MEMBER | Staff information |

LOY OBJ:

The third object entitled LOY_OBJ contains several RFM records or “slots” containing the user behavior data.

Each record is linked to an RFM campaign for which a merchant, or a group of merchants, rewards his customers on their RFM behavior, a merchant that the customer frequents.

The following table gives a list of fields commonly defined in an RFM record or “slot”:

| Name | Description |
|---|---|
| RFM_SLOT_ID | RFM program identifier |
| RFM_SLOT_EXP_DATE | Expiry date |
| RFM_LAST_VISIT_DATE | Date of last visit |
| RFM_VISIT_REGISTER | Total number of visits |
| RFM_AMOUNT_REGISTER | Cumulative purchase amount |
| RFM_PUNCH_REGISTER | Total number of “punches” |

### POOL OBJ:

An additional object called POOL_OBJ contains the rewards of the cash type linked to a determined campaign in which the user participates.

Thus and for example during a campaign, the merchant will give a reward to his customers (either a fixed amount or an amount based on a percentage of the value of the purchase).

The reward may be a number of points or money.

The following table gives a list of fields commonly defined in a POOL record or “slot”.

| Name | Description |
|---|---|
| POOL_SLOT_ID | “Pool” identifier |
| POOL_SLOT_EXP_DATE | Expiry date |
| BALANCE | Current balance |

### CPN OBJ:

An additional object called CPN_OBJ contains the rewards of the electronic coupon type linked to a determined campaign in which the user participates.

Thus and for example during a campaign, the merchant will give a reward to his customers (either a fixed amount or an amount based on a percentage of the value of the purchase) in the form of an electronic coupon.

The following table gives a list of fields commonly defined in a COUPON record or “slot”:

| Name | Description |
|---|---|
| CPN_SLOT_ID | Electronic coupon identifier |
| CPN_SLOT_EXP_DATE | Expiry date |
| COUNTER | Number of coupons of this type |

Still with reference to FIG. 1, the system 1 also comprises a point-of-sale (POS) terminal 13, for example formed of an electronic cash register 14 furnished with a determined promotional program stored in a register 15 of the cash register.

This promotional program makes it possible to provide specific rewards to the consumer in the form of a reduction voucher and/or a printed gift voucher on the bank card slip to be redeemed on the purchase itself or on a subsequent purchase.

Several examples of operations are given below.

The merchant may for example offer a reduction voucher, to be redeemed on a purchase at his store. For example the merchant may grant a 25% reduction to his customers that come for the first time, and 10% to the others.

The merchant may grant an introductory gift; he may offer samples that are for example different for each purchase, he may give a free entry and/or a free meal on each purchase etc.

It is understood here that any type of promotional offer linked to the parameters described above with reference to the files is possible according to the specific algorithm whose programming is within the scope of those skilled in the art, the reward obtained then being printed on the bank card payment coupon.

In one embodiment of the invention, the system 1 also comprises a bar code reader 16 making it possible to enter the references of the purchased products.

FIG. 2 shows an example of a bank card till slip 17 obtained by applying the method according to the invention and showing the elements 18 concerning the bank transaction and the promotional offer 19.

With reference to FIGS. 1 and 3, the operation of a consumer transaction at a merchant's will now be described applying the method sought in the embodiment of the invention more particularly described here.

When a purchase is made at the merchant's, the customer's bank card is inserted at 20 into the reader which prepares the bank authorization request at 21.

The authorization request message is then generated at 22.

In parallel, a promotional program request 23 is made, the latter being generated at 24 in a manner known per se for fulfilling the functionalities determined by the merchant, then transmitted at 25.

The data corresponding to the promotional program(s) are for example incorporated in the bank authorization request at 26, then transmitted (step 27) via the Internet network in a secure manner at 28. The remote server 10 then returns at 29 the application data concerning the customer that are received at 30, transferred at 31 to form a file 32.

The transaction linked to the application data concerning the consumer is then carried out at 33, then the application data are updated at 34, to form the file 35, transferred in its turn at 36 in a possibly different form (diamond 37) to the server 10.

An acknowledgement at 38 is then returned by the server that indicates that the server has indeed processed the transaction, information for example used to trigger the possible printing of the till slip, which terminates the transaction.

Now the operations corresponding to the steps 28, 29 (“image download request” and response) and 35, 36, 37, 38 (“image update request”) are described more precisely below.

### Image Download Request (28)

### Format

| Data | Description |
|---|---|
| Unique card | Unique identification number of the bank |
| number | card (PAN or PAN + additional |
| | information) |
| RFM ID 1 | RFM #1 campaign identifier |
| . . . | |
| RFM ID i | RFM #i campaign identifier |
| POOL ID 1 | POOL #1 identifier |
| . . . | |
| POOL ID j | POOL #j identifier |
| CPN ID 1 | CPN #1 identifier |
| . . . | |
| CPN ID k | CPN #k identifier |

### Response to the “Image Download Request” Message (29)

| Data | Description |
|---|---|
| Unique card | Unique bank card identification number |
| number | |
| CARD_OBJ | Content of the CARD_OBJ object as |
| | defined above |
| ISS_OBJ | Content of the CARD_OBJ object as |
| | defined above |
| LOY_OBJ | Content of the LOY_OBJ object as defined |
| | above |
| POOL_OBJ | Content of the POOL_OBJ object as |
| | defined above |
| CPN_OBJ | Content of the CPN_OBJ object as defined |
| | above |

### Image Update Request (35)

### Format

| Data | Description |
|---|---|
| Unique card | Unique bank card identification number |
| number | |
| CARD_OBJ | New content of the CARD_OBJ object, |
| | comprising in particular the new value |
| | of the UTC transaction counter |
| ISS_OBJ | New content of the ISS_OBJ object |
| LOY_OBJ | New content of the LOY_OBJ object |
| POOL_OBJ | New content of the POOL_OBJ object |
| CPN_OBJ | New content of the CPN_OBJ object |

### Response to the Message (38)

| | | |
|---|---|---|
| Data | Length | Description |

| | |
|---|---|
| Status | Status of the request |

The above text has described the operation of the system and of the method when the application data are obtained from the remote server. On the other hand, when these data are available in the card chip, and as has been seen, these data are taken directly from said chip by the payment terminal of the merchant concerned.

As it goes without saying and as furthermore results from the foregoing, the present invention is not limited to the envisaged embodiments.

On the contrary, it covers all its variants.

1. A method for managing rewards at the time of payment by a user (4) with a bank card (5) with a chip (6) and/or a stripe (7) during a transaction at least one affiliated merchant's, characterized in that, application data of the user being stored (9, 9′) in the chip and/or on an external remote server, and a determined promotional program being stored and/or valid at the merchant's, when the user uses his bank card to pay at said merchant's, the chip and/or said server is interrogated to ascertain the application data relating to this card, then any rewards already acquired are used and/or new rewards are generated as a function of said application data and of said determined promotional program of the merchant before these user application data are updated.

2. The method as claimed in claim 1, characterized in that, the card being a chip card capable of storing the application data, the promotional program processes the transaction and the payment at said merchant's without making use of an external remote server.

3. The method as claimed in claim 1, characterized in that the bank card payment authorization communication protocol is used to interrogate and communicate with the external remote server storing the application data.

4. The method as claimed in claim 1, characterized in that, for a user using a new card replacing an old chip or stripe card, the transaction is processed making use of a remote server in which the application data of said user are stored, then said application data are written into the chip of the new card and the subsequent transactions are carried out without connection to the server.

5. The method as claimed in claim 1, characterized in that, for a user using a new card replacing an old chip card, the application data are read from the chip of the old card, the transaction is processed making use of a remote server into which the application data of the old card of said user are transferred, then the subsequent transactions are carried out with connection to the server.

6. The method as claimed in claim 1, characterized in that the application data are the behavior data of the cardholder and the rewards acquired by this user.

7. The method as claimed in claim 1, characterized in that standard bank cards available on the market are used without modification and/or specific programming, the application data being stored, if appropriate, in a register of said card.

8. The method as claimed in claim 1, characterized in that the user application data are edited in real time when the user uses his bank card at a merchant's.

9. The method as claimed in claim 1, characterized in that the codes of the articles purchased during the transaction are analyzed when one or more articles are identified for which one or more rewards are allocated, the reward being generated accordingly.

10. A system (1) for generating rewards during the payment by a user (4) with a bank card (5) with a chip (6) and/or a stripe (7) during a transaction at least one affiliated merchant's, characterized in that it comprises a register (9, 9′), called the application register, belonging to the card or to an external remote server (10) capable of storing the user application data, and in that it also comprises at said affiliated merchant's:
a point-of-sale terminal (13) furnished with a determined promotional program,
a card reader device (5′) for paying,
means (14) for interrogating the content of the application register of the chip and/or of said server in order to ascertain the application data of said user,
computing means, registering means and means for generating said rewards according to said application data and said determined promotional program stored at the merchant's,
and means for erasing and/or writing in said application register new user application data according to the transaction.

11. The system as claimed in claim 10, characterized in that, the card being a chip card, the promotional program processes the transaction and the payment at said merchant's without making use of an external remote server.

12. The system as claimed in claim 10, characterized in that it comprises means making it possible to use the bank card payment authorization communication protocol to interrogate and communicate with the external remote server for storing application data.

13. The system as claimed in claim 10, characterized in that the application data are the behavior data of the cardholder and the rewards acquired by this user.

14. The system as claimed in claim 10, characterized in that the bank cards are standard cards available on the market without modification and/or specific programming, the application data being stored, as appropriate, in a register of said card.

15. The system as claimed in claim 10, characterized in that it comprises means for real time editing at the merchant's of the user application data when the user uses his bank card at a merchant's.

16. The system as claimed in claim 10, characterized in that it comprises a device for reading the codes of the purchased articles and means arranged for generating rewards according to the promotional program and the identified articles.
